(19) United States
(12) Patent Application Publication
(10) Pub. No.: US 2020/0106967 A1
(43) Pub. Date: Apr. 2, 2020

(54) SYSTEM AND METHOD OF CONFIGURING A VIRTUAL CAMERA

(71) Applicant: CANON KABUSHIKI KAISHA, Tokyo (JP)

(72) Inventor: BELINDA MARGARET YEE, Balmain (AU)

(21) Appl. No.: 16/621,529

(22) PCT Filed: May 31, 2018
(86) PCT No.: PCT/AU2018/000084

§ 371 Date: Dec. 11, 2019

(30) Foreign Application Priority Data
Jun. 16, 2017 (AU) 2017204099

(51) Int. Cl. H04N 5/262; G06T 15/20; G06F 3/0488

(52) U.S. Cl. CPC H04N 5/2628; G06F 3/04883; G06T 15/20

(57) ABSTRACT

A computer-implemented method of configuring a virtual camera. The method comprises receiving, at an interface of an electronic device, a pointing operation identifying a location in a representation of a scene displayed in a first display region; and receiving, at the interface, a further operation in the first display region, the further operation comprising a continuous motion away from the location of the specific operation. The method further comprises configuring the virtual camera based on the location of the pointing operation and at least a direction of the further operation, wherein an image corresponding to the configured virtual camera is displayed, in a second display region, the second display region being different from the first display region.

### TECHNICAL FIELD

The present invention relates to control of virtual cameras, in particular the generation of virtual camera views and the control of virtual camera settings through interaction means.

### BACKGROUND

Image based rendering allows synthesis of a virtual viewpoint from a collection of camera images. For example, in an arrangement where a subject is surrounded by a ring of physical cameras, a new (virtual camera) view of the subject, corresponding to a position in between (physical camera) captured views, can be synthesised from the captured views or video streams if sufficient knowledge of the camera configuration and the scene captured by the physical cameras is available.

In recent times, the ability to synthesise an arbitrary viewpoint has been promoted for the purpose of “free viewpoint” video. In “free viewpoint” video the viewer is able to actively adjust the camera viewpoint to his or her preference within the constraints of the video capture system. Alternatively, a video producer or camera person may employ the free viewpoint technology to construct a viewpoint for a passive broadcast audience. In the case of sport broadcast, the producer or camera person is tasked with constructing virtual camera viewpoints in an accurate and timely manner in order to capture the relevant viewpoint during live broadcast of the sport.

There exist industry standard methods of positioning virtual cameras in virtual environments, such as methods employed in 3D modelling software, used for product concept generation and rendering such as 3D Studio Max. In systems such as 3D Studio Max, virtual cameras are configured by selecting, moving and dragging the virtual camera, the virtual camera's line of sight, or both the virtual camera and the virtual camera's line of sight. The movement of the camera can be constrained by changing the angle from which the 3D world is viewed, by using a 3D positioning widget (e.g., the Gizmo in 3D Studio Max) or by activating constraints in the user interface (UI) e.g. selecting an active plane. In systems such as 3D Studio Max, clicking and dragging with a mouse to set both the camera position and line of sight (orientation) in the 3D environment is possible. However editing other camera settings such as field of view or focal distance is done using user interface controls.

Methods are also known of moving physical cameras in the real world such as remote control of cable cam and drone based cameras. The methods involving remote controls could be used to configure virtual cameras in virtual or real environments. Configuring cable cam and drone cameras involves using one or more joysticks or other hardware controller to change the position and viewpoint of the camera. The cable cam and drone systems can position cameras accurately but not quickly, as time is required to navigate the camera(s) into position. The delay caused by navigation makes the remote control systems less responsive to the action on a sports field, playing field, or stadium which can often be fast-paced. Changing other camera settings such as zoom (field of view), focal distance (focus) is achieved by simultaneously manipulating other hardware controllers such as ‘zoom rockers’ or ‘focus wheels’. Manipulating the hardware controllers often requires two hands, sometimes two operators (four hands), and is time consuming.

Another known method of configuring virtual cameras uses one free air gesture to set both the position and orientation of a camera. The free air gesture involves circling a target object with a finger in mid-air while simultaneously pointing the finger toward the target object. The free air gesture sets two virtual camera settings simultaneously. However, the free air gesture method requires both free air gestures and subsequent gestures or interactions to set other settings of the virtual camera.

The camera control interactions described above are typically inappropriate for applications such as sport broadcast, as camera navigation using the interaction and systems described is relatively time consuming. There remains an unmet need in virtual camera control for a method of generating and controlling a virtual camera view in an accurate and timely manner.

### SUMMARY

It is an object of the present invention to substantially overcome, or at least ameliorate, at least one disadvantage of present arrangements.

One aspect of the present disclosure provides a computer-implemented method of configuring a virtual camera, the method comprising: receiving, at an interface of an electronic device, a pointing operation identifying a location in a representation of a scene displayed in a first display region; receiving, at the interface, a further operation in the first display region, the further operation comprising a continuous motion away from the location of the pointing operation; and configuring a virtual camera based on the location of the pointing operation and at least a direction of the further operation, wherein an image corresponding to the configured virtual camera is displayed in a second display region, the second display region being different from the first display region.

Another aspect of the present disclosure provides a non-transitory computer-readable medium having a computer program stored thereon for configuring a virtual camera, the program comprising: code for receiving, at an interface of an electronic device, a pointing operation identifying a location in a representation of a scene displayed in a first display region; code for receiving, at the interface, a further operation in the first display region, the further operation comprising a continuous motion away from the location of the pointing operation; and code for configuring a virtual camera based on the location of the pointing operation and at least a direction of the further operation, and displaying an image corresponding to the configured virtual camera in a second display region, the second display region being different from the first display region.

Another aspect of the present disclosure provides a system, comprising: an interface; a display; a memory; and a processor, wherein the processor is configured to execute code stored on the memory for implementing a method of configuring a virtual camera, the method comprising: receiving, at the interface, a pointing operation identifying a location in a representation of a scene displayed in a first display region; receiving, at the interface, a further operation in the first display region, the further operation comprising a continuous motion away from the location of the pointing operation; configuring the virtual camera based on the location of the pointing operation and at least a direction of the further operation; wherein an image corresponding to the configured virtual camera is displayed in a second display region, the second display region being different from the first display region.

Another aspect of the present disclosure provides a tablet device adapted to configure a virtual camera, comprising: a touchscreen; a memory; a processor configured to execute code stored on the memory to: display a video representation of a scene in a first region of the touchscreen; receive, at the touchscreen, a pointing operation identifying a location in the scene in the first region; receive, at the touchscreen, a further operation in the first region, the further operation comprising a continuous motion away from the location; configure the virtual camera based on the location of the pointing operation and at least a direction of the further operation; and display an image corresponding to the configured virtual camera in a second region of the touchscreen, the second region being different from the first region.

Another aspect of the present disclosure provides a computer-implemented method of configuring a virtual camera, the method comprising: receiving, at an interface of an electronic device, an initial touch at a location on a representation of a playing field displayed by the electronic device; identifying, via the interface, a direction of a first motion away from the location of the initial touch, the first motion being a continuous motion from the initial touch; identifying, via the interface, a length of a second motion, away from the received direction of the first motion, the second motion being a continuous motion from the first motion; and generating the virtual camera at the location of the initial touch in the playing field, the virtual camera having an orientation based on the identified direction of the first motion and a field of view based on the identified length of the second motion.

In some aspects, the interface is a touchscreen, and each of the first motion and the second motion is a swipe gesture applied to the touchscreen.

In some aspects, the method further comprises determining an angle of the second motion relative to the first motion, and determining an extent of the virtual camera based on the angle.

In some aspects, the angle is within a predetermined threshold.

In some aspects, the method further comprises determining objects in the field of view of the virtual camera and highlighting the detected objects.

In some aspects, the location of the initial touch is determined to be a location of an object in the playing field, and the virtual camera is configured to maintain a location relative to the object as the object moves about the playing field.

In some aspects, the object is a player the virtual camera is configured to track a viewpoint of the person.

In some aspects, the first motion ends on an object on the playing field and the virtual camera is generated to track the object.

In some aspects, the virtual camera is generated to have a height based on a duration of the initial touch.

In some aspects, the interface comprises a hover sensor, the initial touch is a hover gesture, and a height of the virtual camera is determined based on a height of the hover gesture.

In some aspects, the interface is a touchscreen and a height of the virtual camera is determined using pressure applied to the touchscreen during the initial touch.

In some aspects, if the second motion traces back along a trajectory of the first motion, the virtual camera is configured to have a depth of field based on the determined length of the second motion.

In some aspects, the method further comprises detecting, at the interface a further touch gesture at the location on the playing field, displaying an indication of the initial touch gesture, the first motion and the second motion; and receiving a gesture updating one of the first motion and the second motion to update the virtual camera.

In some aspects, if the initial touch is at a location of an object in the playing field, and the second motion is at an angle relative to the first motion between two predetermined thresholds, the virtual camera is generated to orbit the object.

In some aspects, a length of the first motion gesture is used to determine a radius of an orbital path of the virtual camera relative to the object.

Another aspect of the present disclosure provides a non-transitory computer-readable medium having a computer program stored thereon for configuring a virtual camera, the program comprising: code for receiving, at an interface of an electronic device, an initial touch at a location on a representation of a playing field displayed by the electronic device; code for identifying, via the interface, a direction of a first motion away from the location of the initial touch, the first motion being a continuous motion from the initial touch; code for identifying, via the interface, a length of a second motion, away from the received direction of the first motion, the second motion being a continuous motion from the first motion; and code for generating the virtual camera at the location of the initial touch in the playing field, the virtual camera having an orientation based on the identified direction of the first motion and a field of view based on the identified length of the second motion.

Another aspect of the present disclosure provides a system, comprising: an interface; a display; a memory; and a processor, wherein the processor is configured to execute code stored on the memory for implementing a method of configuring a virtual camera, the method comprising: receiving, at the interface, an initial press touch at a location on a representation of a playing field displayed on display; identifying, via the interface, a direction of a first motion away from the location of the initial touch, the first motion being a continuous motion from the initial touch; identifying, via the interface, a length of a second motion, away from the received direction of the first motion, the second motion being a continuous motion from the first motion; and generating the virtual camera in the playing field at the location of the initial touch in the playing field, with the virtual camera having an orientation of based on the received identified direction of the first motion and a field of view based on the received identified length of the second motion.

Another aspect of the present disclosure provides a tablet device adapted to configure a virtual camera, comprising: a touchscreen; a memory; a processor configured to execute code stored on the memory to: display, on the touchscreen, a video representation of a playing field; receive, at the touchscreen, an initial touch at a location on the representation of the playing field; identify, via the touchscreen, a direction of a first motion away from the location of the initial touch, the first motion being a continuous motion from the initial touch; identify, via the touchscreen, a length of a second motion, away from the received direction of the first motion, the second motion being a continuous motion from the first motion; and generate a virtual camera at the location of the initial touch in the playing field, the virtual camera having an orientation based on the identified direction of the first motion and a field of view based on the identified length of the second motion.

### BRIEF DESCRIPTION OF THE DRAWINGS

One or more example embodiments of the invention will now be described with reference to the following drawings, in which:

FIG. 1 shows an arrangement of networked video cameras surrounding a sports stadium;

FIG. 2 shows a schematic flow diagram of a method of configuring a virtual camera;

FIGS. 3A and 3B show a gesture for configuring a virtual camera;

FIGS. 4A and 4B show gestures for configuring a virtual camera to show an object's point of view;

FIGS. 5A and 5B show gestures for configuring a virtual camera where virtual camera height is actively defined.

FIG. 6 shows a gesture for configuring a virtual camera where depth of field is actively defined.

FIGS. 7A and 7B show a method for editing virtual camera attributes post generation.

FIGS. 8A and 8B relate to a gesture for configuring a virtual camera with constrained movement.

FIGS. 9A and 9B collectively form a schematic block diagram representation of an electronic device upon which described arrangements can be practised.

### DETAILED DESCRIPTION INCLUDING BEST MODE

As described above, known methods of generating and controlling a virtual camera view are often unsuitable for applications which require relatively quick virtual camera configuration, such as live sports broadcast.

In the system described herein, definition of characteristics of a virtual camera is achieved by a user making a gesture using an interface such as a touchscreen. Attributes of the gesture define multiple characteristics of the virtual camera. The gesture allows a virtual camera to be configured in timeframes required by a responsive virtual sport broadcast system.

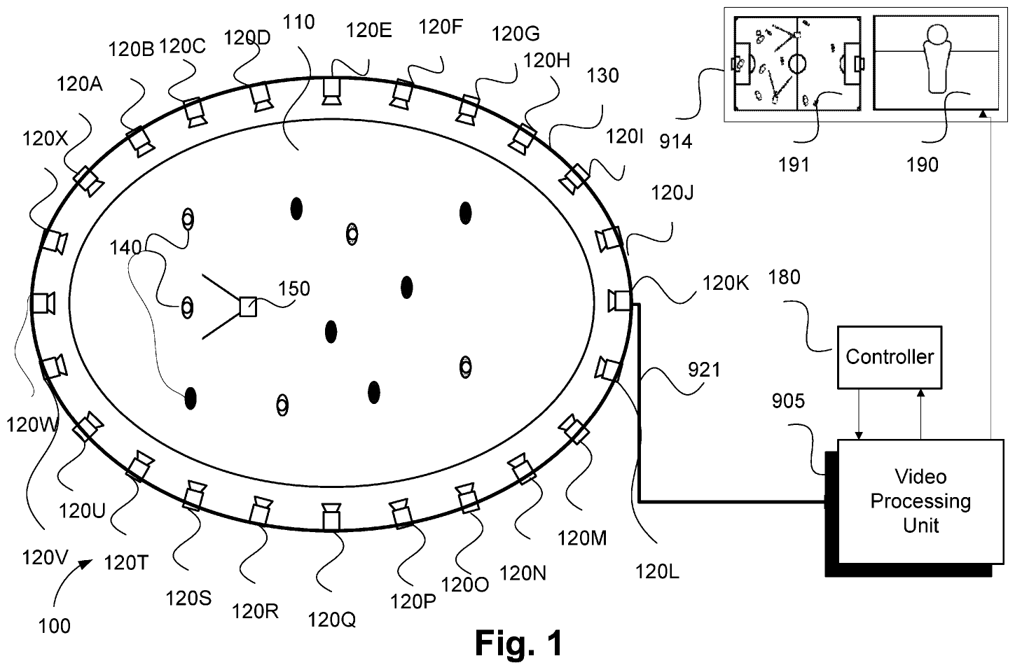

The methods described herein are intended for use in the context of a performance arena being a sports or similar performance field as shown in FIG. 1. A system 100, includes an arena 110 assumed to be centred on a real physical playing field that is approximately rectangular, oval or circular. The shape of the field 110 allows the field 110 to be surrounded by one or more rings of physical cameras 120A to 120X. In the example arrangement 100, the arena 110 is a field. However in other arrangement, the arena 110 could be a music stage, theatre, a public or a private venue, or any venue having a similar arrangement of physical cameras and a known spatial layout. For example, the arrangements described could also be used for surveillance in an arena such as a train station platform.

The field 110, in the example of FIG. 1, contains objects 140. Each of the objects 140 can be a person, a ball, a vehicle or any structure on the field 110. The cameras 120A to 120X are synchronised to acquire frames at the same instants in time so that all points on the field 110 are captured simultaneously from a large number of viewpoints. In some variations, a full ring of cameras is not employed but rather some subsets of the full perimeter are employed. The arrangement using subsets of the full perimeter may be advantageous when certain viewpoints are known to be unnecessary ahead of time.

The video frames captured by the cameras 120A-120X are subject to processing and temporary storage near the cameras 120A-120X prior to being made available via a network connection 921 to a video processing unit 905. The video processing unit 905 receives controlling input from an interface of a controller 180 that specifies position, orientation, zoom and possibly other simulated camera features for a virtual camera 150. The virtual camera 150 represents a location, direction and field of view generated from video data received from the cameras 120A to 120X. The controller 180 recognizes input (such as screen touch or mouse click) from the user. Recognition of touch input from the user can be achieved through a number of different technologies, such as capacitance detection, resistance detection, conductance detection, vision detection and the like. The video processing unit 905 is configured to synthesise a specified virtual camera perspective view 190 based on the video streams available to the unit 905 and display the synthesised perspective on a display terminal 914. The virtual camera perspective view 190 relates to a video view that the virtual camera 150 captures. The display terminal 914 could be one of a variety of configurations for example, a touchscreen display, an LED monitor, a projected display or a virtual reality headset. If the display terminal 914 is a touchscreen, the display terminal 914 may also provide the interface of the controller 180. The virtual camera perspective view 190 represents frames of video data resulting from generation of the virtual camera 150.

“Virtual cameras” are referred to as virtual because the functionality of the virtual cameras is computationally derived by methods such as interpolation between cameras or by rendering from a virtual modelled 3d scene constructed using data from many cameras (such as the cameras 120A to 120X) surrounding the scene (such as the field 110), rather than simply the output of any single physical camera.

A virtual camera location input may be generated in known arrangements by a human virtual camera operator and be based on input from a user interface device such as a joystick, mouse or similar controller including dedicated controllers comprising multiple input components. Alternatively, the camera position may be generated fully automatically based on analysis of the game play. Hybrid control configurations are also possible whereby some aspects of the camera positioning are directed by a human operator and others by an automated algorithm. Examples of the latter include the case where coarse positioning is performed by a human operator and fine positioning, including stabilisation and path smoothing is performed by the automated algorithm.

The video processing unit 905 achieves frame synthesis using image based rendering methods known in the art. The rendering methods are based on sampling pixel data from the set of cameras 120A to 120X of known geometric arrangement. The rendering methods combine the sampled pixel data information into a synthesised frame. In addition to sample based rendering of the requested frame, the video processing unit 905 may also perform synthesis, 3D modelling, in-painting or interpolation of regions as required covering sampling deficiencies and creating frames of high quality visual appearance. The processor 905 may also provide feedback in the form of the frame quality or the completeness of camera coverage for the requested viewpoint so that the device generating the camera position control signal can be aware of the practical bounds of the processing system. An example video view 190 created by the video processing unit 905 may subsequently be provided to a production desk (not depicted) video streams received from the cameras 120A to 120X can be edited together to form a broadcast video. Alternatively the virtual camera perspective view 190 might be broadcast unedited or stored for later compilation.

The processor 905 is also typically configured to perform image analysis including object detection and object tracking on video data captured by the cameras 120A to 120X. In particular, the video processing unit 905 can be used to detect and track objects in a virtual camera field of view. In alternative arrangements, the objects 140 in the field 110 can be tracked using sensors attached to the objects, for example sensors attached to players or a ball.

The flexibility afforded by the computational video capture system of FIG. 1 described above presents a secondary set of problems not previously anticipated in live video coverage using physical cameras. In particular, as described above problems have been identified in, how to generate a virtual camera anywhere on a sports field, at any time in response to the action on the field.

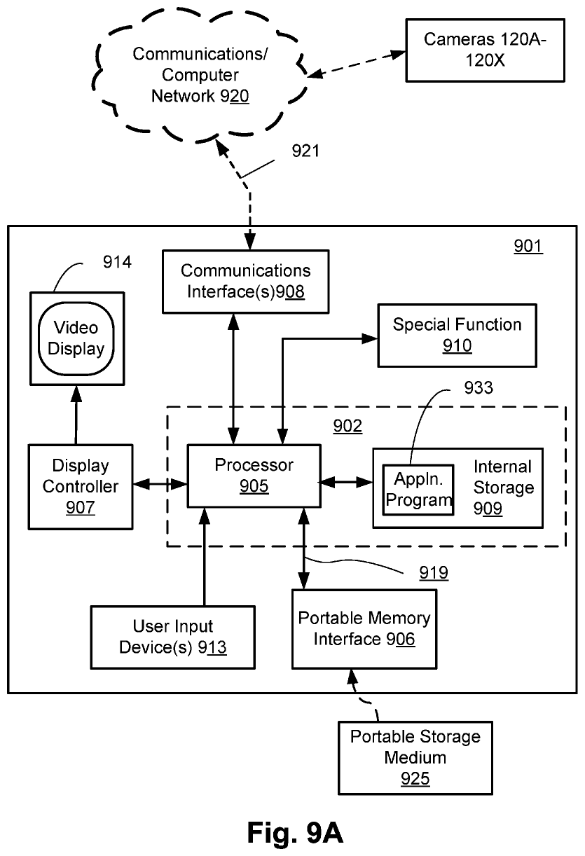

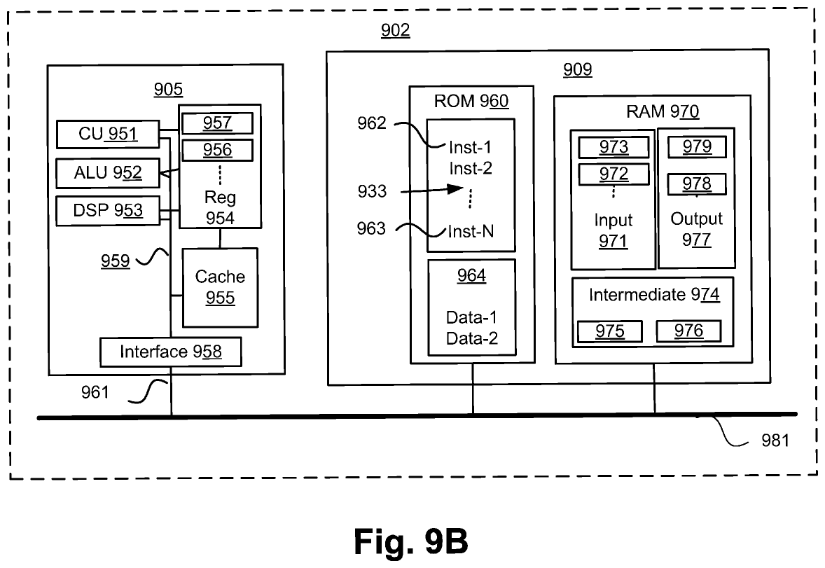

FIGS. 9A and 9B depict a collectively form a schematic block diagram of a general purpose electronic device 901 including embedded components, upon which the methods to be described are desirably practiced. In the arrangements described, the controller 180 of FIG. 1 is integral to the electronic device 901, a tablet device. In other arrangements, the controller 180 may form part of a separate device (for example a tablet) to the video processing unit 905 (for example a cloud server), the separate devices in communication over a network such as the internet.

The electronic device 901 may be, for example, a mobile phone or a tablet, in which processing resources are limited. Nevertheless, the methods to be described may also be performed on higher-level devices such as desktop computers, server computers, and other such devices with significantly larger processing resources.

As seen in FIG. 9A, the electronic device 901 comprises an embedded controller 902. Accordingly, the electronic device 901 may be referred to as an “embedded device.” In the present example, the controller 902 has the processing unit (or processor) 905 which is bi-directionally coupled to an internal storage module 909. The internal storage module 909 may be formed from non-volatile semiconductor read only memory (ROM) 960 and semiconductor random access memory (RAM) 970, as seen in FIG. 9B. The RAM 970 may be volatile, non-volatile or a combination of volatile and non-volatile memory.

The electronic device 901 includes a display controller 907, which is connected to a video display 914, such as a liquid crystal display (LCD) panel or the like. The display controller 907 is configured for displaying graphical images on the video display 914 in accordance with instructions received from the embedded controller 902, to which the display controller 907 is connected.

The electronic device 901 also includes user input devices 913 which are typically formed by keys, a keypad or like controls. In a preferred implementation, the user input devices 913 include a touch sensitive panel physically associated with the display 914 to collectively form a touch-screen. The touch-screen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus. In the arrangements described, the touchscreen 914 forms the interface of the controller 180 via which gestures are received to generate the virtual camera 150. However, in some implementations, the gestures can be received via a graphical user interface using different inputs of the devices 913, such as a mouse.

As seen in FIG. 9A, the electronic device 901 also comprises a portable memory interface 906, which is coupled to the processor 905 via a connection 919. The portable memory interface 906 allows a complementary portable memory device 925 to be coupled to the electronic device 901 to act as a source or destination of data or to supplement the internal storage module 909. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The electronic device 901 also has a communications interface 908 to permit coupling of the device 901 to a computer or communications network 920 via a connection 921. The connection 921 may be wired or wireless. For example, the connection 921 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like. The physical cameras 120A to 120X typically communicate with the electronic device 901 via the connection 921.

Typically, the electronic device 901 is configured to perform some special function. The embedded controller 902, possibly in conjunction with further special function components 910, is provided to perform that special function. For example, where the device 901 is a tablet, the components 910 may represent a hover sensor or a touchscreen of the tablet. The special function components 910 is connected to the embedded controller 902. As another example, the device 901 may be a mobile telephone handset. In this instance, the components 910 may represent those components required for communications in a cellular telephone environment. Where the device 901 is a portable device, the special function components 910 may represent a number of encoders and decoders of a type including Joint Photographic Experts Group (JPEG), (Moving Picture Experts Group) MPEG, MPEG-1 Audio Layer 3 (MP3), and the like.

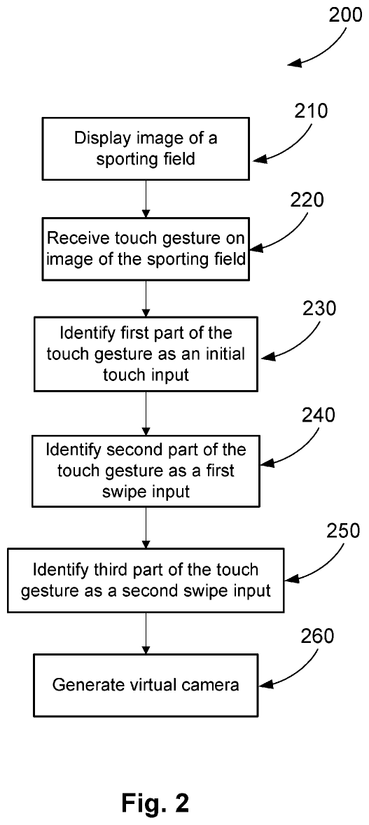

The methods described hereinafter may be implemented using the embedded controller 902, where the processes of FIGS. 2 to 8 may be implemented as one or more software application programs 933 executable within the embedded controller 902. The electronic device 901 of FIG. 9A implements the described methods. In particular, with reference to FIG. 9B, the steps of the described methods are effected by instructions in the software 933 that are carried out within the controller 902. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 933 of the embedded controller 902 is typically stored in the non-volatile ROM 960 of the internal storage module 909. The software 933 stored in the ROM 960 can be updated when required from a computer readable medium. The software 933 can be loaded into and executed by the processor 905. In some instances, the processor 905 may execute software instructions that are located in RAM 970. Software instructions may be loaded into the RAM 970 by the processor 905 initiating a copy of one or more code modules from ROM 960 into RAM 970. Alternatively, the software instructions of one or more code modules may be pre-installed in a non-volatile region of RAM 970 by a manufacturer. After one or more code modules have been located in RAM 970, the processor 905 may execute software instructions of the one or more code modules.

The application program 933 is typically pre-installed and stored in the ROM 960 by a manufacturer, prior to distribution of the electronic device 901. However, in some instances, the application programs 933 may be supplied to the user encoded on one or more CD-ROM (not shown) and read via the portable memory interface 906 of FIG. 9A prior to storage in the internal storage module 909 or in the portable memory 925. In another alternative, the software application program 933 may be read by the processor 905 from the network 920, or loaded into the controller 902 or the portable storage medium 925 from other computer readable media. Computer readable storage media refers to any non-transitory tangible storage medium that participates in providing instructions and/or data to the controller 902 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 901. Examples of transitory or non-tangible computer readable transmission media that may also participate in the provision of software, application programs, instructions and/or data to the device 901 include radio or infrared transmission channels as well as a network connection to another computer or networked device, and the Internet or Intranets including e-mail transmissions and information recorded on Websites and the like. A computer readable medium having such software or computer program recorded on it is a computer program product.

The second part of the application programs 933 and the corresponding code modules mentioned above may be executed to implement one or more graphical user interfaces (GUIs) to be rendered or otherwise represented upon the display 914 of FIG. 9A. Through manipulation of the user input device 913 (e.g., the keypad), a user of the device 901 and the application programs 933 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 9B illustrates in detail the embedded controller 902 having the processor 905 for executing the application programs 933 and the internal storage 909. The internal storage 909 comprises read only memory (ROM) 960 and random access memory (RAM) 970. The processor 905 is able to execute the application programs 933 stored in one or both of the connected memories 960 and 970. When the electronic device 901 is initially powered up, a system program resident in the ROM 960 is executed. The application program 933 permanently stored in the ROM 960 is sometimes referred to as “firmware”. Execution of the firmware by the processor 905 may fulfil various functions, including processor management, memory management, device management, storage management and user interface.

The processor 905 typically includes a number of functional modules including a control unit (CU) 951, an arithmetic logic unit (ALU) 952, a digital signal processor (DSP) 953 and a local or internal memory comprising a set of registers 954 which typically contain atomic data elements 956, 957, along with internal buffer or cache memory 955. One or more internal buses 959 interconnect these functional modules. The processor 905 typically also has one or more interfaces 958 for communicating with external devices via system bus 981, using a connection 961.

The application program 933 includes a sequence of instructions 962 through 963 that may include conditional branch and loop instructions. The program 933 may also include data, which is used in execution of the program 933. This data may be stored as part of the instruction or in a separate location 964 within the ROM 960 or RAM 970.

In general, the processor 905 is given a set of instructions, which are executed therein. This set of instructions may be organised into blocks, which perform specific tasks or handle specific events that occur in the electronic device 901. Typically, the application program 933 waits for events and subsequently executes the block of code associated with that event. Events may be triggered in response to input from a user, via the user input devices 913 of FIG. 9A, as detected by the processor 905. Events may also be triggered in response to other sensors and interfaces in the electronic device 901.

The execution of a set of the instructions may require numeric variables to be read and modified. Such numeric variables are stored in the RAM 970. The disclosed method uses input variables 971 that are stored in known locations 972, 973 in the memory 970. The input variables 971 are processed to produce output variables 977 that are stored in known locations 978, 979 in the memory 970. Intermediate variables 974 may be stored in additional memory locations in locations 975, 976 of the memory 970. Alternatively, some intermediate variables may only exist in the registers 954 of the processor 905.

The execution of a sequence of instructions is achieved in the processor 905 by repeated application of a fetch-execute cycle. The control unit 951 of the processor 905 maintains a register called the program counter, which contains the address in ROM 960 or RAM 970 of the next instruction to be executed. At the start of the fetch execute cycle, the contents of the memory address indexed by the program counter is loaded into the control unit 951. The instruction thus loaded controls the subsequent operation of the processor 905, causing for example, data to be loaded from ROM memory 960 into processor registers 954, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 933, and is performed by repeated execution of a fetch-execute cycle in the processor 905 or similar programmatic operation of other independent processor blocks in the electronic device 901.

In the arrangements described the controller 180 relates to the touchscreen 914 of the tablet device 901. The touchscreen 914 provides an interface with which the user may interact with a displayed representation of the field 110, and watch video footage associated with the field 110.

The present disclosure relates to a method of configuring a virtual camera using a gesture consisting of component parts or operations, each component part defining an attribute of the virtual camera view. The gesture comprising the component parts is a single, continuous gesture.

FIG. 2 shows a method 200 of configuring a virtual camera 150 using a gesture received via the interface 914. The method 200 can be implemented as one or more modules of the software application 933, stored in the memory 909, and controlled over execution of the processor 905.

The method 200 starts at a displaying step 210. At step 210, the video processing unit 170 executes to generate a synthesised virtual camera view, represented by the video view 190, and a synthesised interaction view 191 of the virtual modelled 3d sporting field 110. The interaction view 191 provides a representation of the scene such as the playing field 110 with which a user can interact to control the placement of virtual camera 150. The representation can relate to a map of the playing field 110 or a captured scene of the playing field 110. The step 210 executes to display the views 190 and 191 on the display terminal 914. As shown in FIG. 1, the views 190 and 191 are typically displayed in different regions of the display 914. In one arrangement of the disclosure, view 191 is a first display region while view 190 is a second display region, both the first and second display regions forming part of the display 914. Alternatively, the first display region and the second display region can be in different display devices respectively. The different display devices can be connected with the display controller 907. The synthesised interaction view 191 may be a top down view covering the whole field 110, or alternatively could be any other full or partial view of the field 110 including horizontal perspective views across the field 110, such as views generated by the virtual camera 150. The display terminal 914 and the controller 180 may be components of one device such as in a touchscreen display or may be separate devices such as a projected display and a camera sensor and vision detection system for gesture recognition. An initial location of the initial synthesized view 190 may be a predetermined default, set by a previous user interaction, or determined automatically based on action of the field.

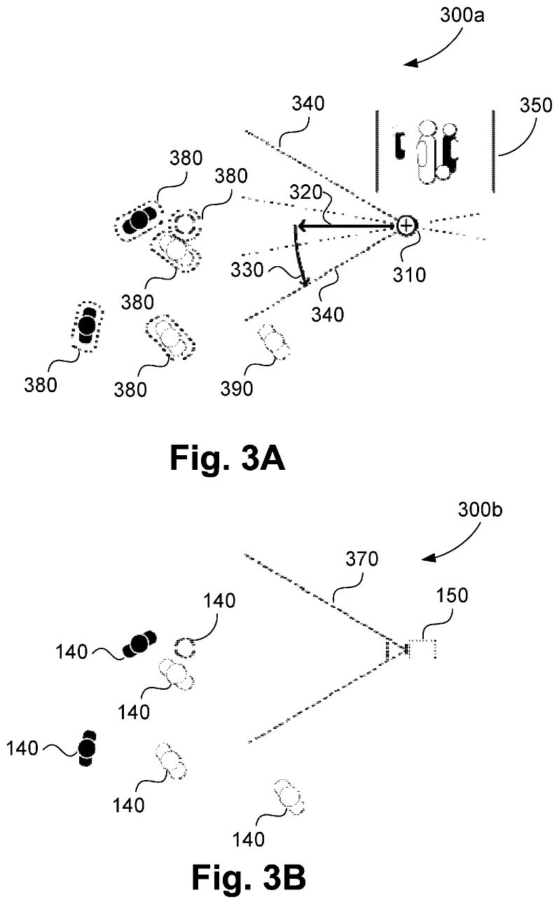

The method 200 continues under execution of the processor 905 from step 210 to a receiving step 220. At step 220 the controller 180 receives a pointing operation, in the example described a touch gesture input, from the user on the synthesised interaction view 191. For example, the user touches the touchscreen 914 with a finger. Alternatively, the gesture can relate to a user operating an input device, for example clicking a mouse. The gesture received at the touchscreen interface 914 representation is an initial operation of the overall continuous gesture. The method 200 progresses under control of the processor 905 to a first recognising step 230. At step 230 a first part of a touch gesture is recognised by the video processing unit 905. An example initial touch 310 input is shown in an arrangement 300 in FIG. 3A. The method 200 operates to associates the recognised touch with a location on the synthesised interaction view 191 of the field 110. The location can be stored on the device 901, for example in the memory 909. In some arrangements, the step 230 executes to generate and display a dynamic virtual camera preview on a portion of the touchscreen display 914 upon determining the location. The virtual camera preview relates to a view from a virtual camera at the location, in an arbitrary direction or in a default direction. An example of a default direction is towards a nearest goal post.

The method 200 continues under control of the processor 905 from step 230 to a second recognising or identifying step 240. At step 240 the controller 180 receives a second operation or a further operation of the touch gesture. The second operation or further operation of the gesture comprises a first swipe input applied to the touchscreen 914, indicated by an arrow 320 in FIG. 3A. The swipe gesture is a continuous motion away from the initial touch (pointing) input 310's location. If the gesture relates to operation of an input device, a corresponding continuous motion, such as a hold and drag operation of a mouse can be identified. The video processing unit 905 identifies the swipe gesture, and records the identified gesture as first swipe input or a first motion. The video processing unit 905 also operates to determine an attribute (e.g. direction or length) of the first swipe input 320. The initial touch (pointing) input 310 and the first swipe input 320 form a single continuous gesture. The processor 905 operates to store identification and direction of the first swipe input or the first motion 320, for example in the memory 909.

In some arrangements, step 240 operates to generate and display a dynamic preview of the virtual camera based on the identified first motion (swipe) using the video display 914. The virtual camera preview differs from the virtual camera preview of step 230 as the virtual camera preview relates to the location of the first input 310 along a direction of the first swipe input 320. The dynamic preview effectively operates to provide a real time image associated with the virtual camera in the view 190 as the first motion is received.

The method 200 proceeds under execution of the processor 905 from step 240 to a third recognising step 250. At step 250 the controller 180 receives a third part of the touch gesture applied to the touchscreen 914 with continuous motion away from the first swipe 320 input at an angle relative to the first swipe. The continuous motion away from the first motion or first swipe 320 represents a second motion 330. The second or further operation can be considered to comprise both the first motion of step 240 and the second motion of step 250. The application 933 determines the angle (field of view) and an extent of the virtual camera 150 based on the angle. The angle is preferably greater than a predetermined threshold, for example fifty degrees. The threshold is typically between ten degrees and one hundred and seventy degrees or between one hundred and ninety degrees and three hundred and fifty degrees to allow for normal variation (instability) in the first swipe input 320. The third part of the recognised touch gesture is effectively a second swipe gesture or the second motion. The second swipe input or gesture, shown as 330 in FIG. 3A determines a field of view of the virtual camera 150. Accordingly, a reasonable assumption is that the second swipe input 300 should also fall outside of one hundred and seventy degrees and one hundred and ninety degrees. The assumption is made as a swipe too close to one hundred and eighty degrees is not sufficient deviation from the first swipe input 320.

The video processing unit 905 recognises the second swipe input 330, meeting the threshold requirements. The initial touch input 310, the first swipe input 320 and the second swipe input 330 form a single continuous gesture. The computer module 901 is operable to configure the basic virtual camera 150. To configure the basic virtual camera 150, the video processing unit 905, in step 250 determines a length of the second swipe input 330 away from the end of the first swipe input 320. A field of view line 340, shown in FIG. 3A is drawn between the initial (pointing) touch 310 location and the end of the second swipe 330 relative to the representation of the playing field 110. The field of view line 340, when mirrored about the first swipe input 320, defines a horizontal extent of the virtual camera 150's field of view. A resultant field of view 370 of the virtual camera 150 is shown in an arrangement 300b in FIG. 3B. In some arrangements, an updated dynamic virtual camera preview is generated in execution of step 250. The dynamic preview relates to the field of view 370.

The method 200 continues under execution of the processor 905 from step 250 to a generating step 260. At step 260 the application 933 executes to generate the basic virtual camera 150. The orientation of the virtual camera 150 is based on the identified direction of the first motion and the field of view of the virtual camera 150 is based on the identified length of the second motion. The virtual camera 150 is positioned at the location of the initial touch input 310, and has an orientation so that the line of sight follows the direction of the first swipe input 320, and set to have the field of view 370 extend according to the field of view line 340 determined from the length of the second swipe input 330 which determines the angle of the second swipe input 330 relative to the first swipe input 320. The application 933 executes to save settings defining the virtual camera view 150, such as location, direction, field of view and the like. In another implementation, a plurality of predefined virtual cameras can be associated with the scene (the field 110). The predefined virtual cameras can be configured from the cameras 120A to 120X, for example by a user of the controller 180 prior to start of the game. The step 260 operates to select one of the predefined cameras in the implementation. For example, a predefined camera having direction and/or field of view most similar, or within a predetermined threshold of direction and/or field of view may be selected.

Some implementations relate to generating dynamic previews at steps 240 and 260 as described above. Other implementations relate to generating the image or video data for the view 190 at step 260 after the virtual camera has been generated or configured.

As the user inputs the touch gestures 310, 320 and 330, a virtual camera preview 350 (FIG. 3A) can be presented on the video display 914 showing the composition of the virtual camera view 190. The virtual camera preview 350 is dynamic and ceases display when the user ends the gesture, or ends contact with the touchscreen of the controller 180. In contrast, the virtual camera generated at step 260 is saved to memory (such as in the memory 309) and operated even after the user ends the gesture.

The application 933 can also use image analysis techniques for object detection on images captured by the cameras 120A to 120X in the region of the view of the virtual camera 150 at step 260. Objects 380 detected as being in the field of view of the virtual camera 150, that is captured in the virtual camera view 190, are highlighted, as shown FIG. 3A. Any detected object, such as an object 390, not included in the virtual camera view 190, is not highlighted. The visual prompts of highlighting and not highlighting allow the user to modify the overall gesture during input to improve final composition of the virtual camera 150.

If after completing the gesture, one of the highlighted objects 380 moves out of the field of view 370 extents or limits, the field of view 370 extents can be modified in execution of step 260 to ensure that the highlighted object remains in the virtual camera view 190. For example, extents for an angle of a field of view 370, shown in FIG. 3B, are modified by the change in degrees the highlighted object 380 moved by execution of the application 933. The change in degrees of the highlighted object is determined by the application 933 using the same axis as the angle of field of view. One or both of orientation and field of view can be changed.

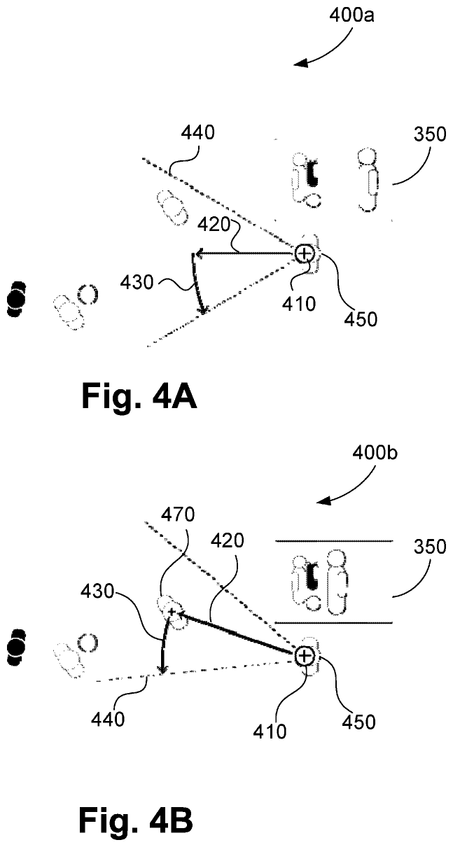

FIG. 4A shows an alternative arrangement 400a for a method of configuring the virtual camera 150 to generate the virtual camera view 190. In the arrangement of FIG. 4A, the virtual camera view 190 reflects a viewpoint of an object on the field 110, such as a player or referee. The virtual camera 150 and resultant view 190 are determined using the three-part gesture described in relation to FIG. 2. Effectively, the arrangement described in relation to FIG. 4A provides an ‘object-view’ camera such as a ‘Ref-cam’ (referee camera). The arrangement 400a shows the interactions required to configure or set up a basic ‘object-view’ virtual camera. An arrangement 400b in FIG. 4B shows the interactions required to setup an ‘object-view’ virtual camera having a line of sight that tracks another selected object 470 on the field 110.

In the example of FIG. 4A, the first part of the touch gesture is recognised by the video processing unit 905 as an initial touch 410 input on the synthesised interaction view 191 in the same location as an object 450 on the field 110. The virtual camera 150 created in step 260 is positioned in a meaningful manner according to the touched object 450. For example, if the object is a ball, the virtual camera 150 is positioned in the centre of the ball. If the object is a person, for example a referee, the virtual camera 150 is positioned in the person's head. A key attribute of an object-view camera is that the virtual camera 150 changes position as the position of the object changes. For example, the location of the virtual camera 150 is updated to track movements of the person relative to the field 110. The virtual camera 150 is effectively tethered to the object and maintains a position or location relative to the object as the object moves about the field.

At step 240 the controller 180 receives a second part (i.e. the first motion of the further operation) of the continuous touch gesture, input 420. The second gesture 420 has a continuous motion away from the location of the initial touch input 410. The video processing unit 905 recognises the input 420 as a swipe gesture, and records the gesture 420 as the first swipe input. The virtual camera 150 created in step 260 and positioned at 410 is oriented to have a line of sight following the direction of the first swipe input 420. If the touched object 450 is a person the line of sight angle of the virtual camera 150 is locked relative to the forward direction of the person's head. The direction of the person's head is typically determined using facial recognition processing techniques for video data captured by relevant ones of the cameras 120A to 120X. If the person rotates their head, the application 933 executes at steps 240 to 260 to identify the rotation using facial recognition techniques on the video streams and rotates the virtual camera 150 by the same amount and in the same direction. The virtual camera 150 accordingly tracks and simulates the viewpoint of the person.

At step 250 the controller 180 receives a third part 430 of the touch gesture with continuous motion away from the first swipe 420 input at an angle greater than the predetermined threshold. The video processing unit 905 recognises the third part 430 as the second swipe input (i.e. the second motion of the further operation). The video processing unit 905 determines the length of the second swipe input 430 away from the end of the first swipe input 420. A field of view line 440 is drawn between the initial touch location 410 and the end of the second swipe 430. The field of view line 430, is mirrored about the first swipe input 420 to define the horizontal extents of the field of view of the virtual camera 150 created in execution of step 260.

As shown in the arrangement 400b of FIG. 4B, the first swipe gesture 420 can extend toward and end on a second object 470. Presence of the object is detected as described above. The line of sight of the virtual camera 150 is not locked relative to the touched object 450 head. Rather, if the first swipe gesture ends on a second object in this event, the line of sight of the virtual camera 150 tracks the position of the second object 470 so that the object 470 is kept near the centre of the virtual camera view 190. If the location of the first touch gesture was not at an object, but the first swipe gesture ends on an object, the virtual camera 150 is still typically configured to track the object at the end of the first swipe gesture 420.

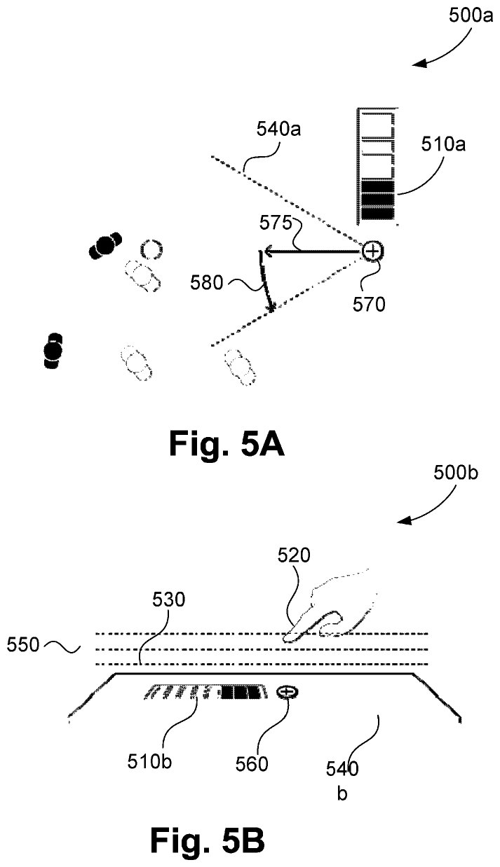

FIGS. 5A and 5B show another implementation of a method of configuring the virtual camera 150 at various heights above the field 110 using a three part gesture. In the arrangements described above, the virtual camera 150 is created at a default height, for example 1.5 m. The default height may be set by the user and is typically determined through experimentation. The height is preferably a reasonable default which allows the virtual camera view 190 to be near head height for players on the field 110, for example an average height of players based upon age range and/or gender.

FIG. 5A shows an arrangement 500a describing interactions required to set the virtual camera height using a touch screen of the electronic device 901. An arrangement 500b shown in FIG. 5B shows the interactions required to set the virtual camera height where the electronic device 901 is configured to sense proximity or hover gestures, for example using an infrared camera sensor.

In the arrangement where the controller 180 relates to a touchscreen, as shown in FIG. 5A, the controller 180 receives an initial touch 570 input on the synthesised interaction view 191 at step 230. Height of the virtual camera 150 is determined based on a duration of the initial touch. The height is determined if the duration of the initial touch is longer than a threshold, for example 500 ms. The threshold is typically predetermined through experimentation for a particular sport and/or arena. The prolonged hold over the threshold infers intent by the user. If a relatively short threshold were used, the user could inadvertently trigger the height adjustment. The duration of the initial touch 570 input beyond the 500 ms threshold, determines the height of the virtual camera 150 off the ground of the field 110. As the user prolongs the initial touch input 570 the camera height setting is increased, and is shown on a height indicator 510a on the video display 914. The height can be increased up to a limit, for example 20 metres. The height limit is determined by position of the ring of cameras 120A to 120X. After the height limit has been reached, further continuous application of the prolonged touch causes the height of the virtual camera 150 to decrease. The height indicator 510a may be a graphic or may be text.

In another implementation, the touchscreen 914 is a touchscreen configured to measure pressure applied to the touchscreen. In such arrangements, the height of the virtual camera 150 is determined using pressure applied to the touchscreen during the initial touch. At step 220, an initial touch over a pressure threshold is identified, and a greatest pressure applied prior to the second gesture (first swipe or first motion) is used to determine height of the virtual camera 150. The user applies the initial touch by touching and applying pressure to the touchscreen 914. The pressure threshold and a pressure scale used to vary height are typically determined according to manufacturer specifications of the touchscreen. As the user increases the pressure, the height setting of the virtual camera 150 is increased, and is shown on the height indicator 510a. After the height limit has been reached, further continuous application of pressure causes the height of the virtual camera 150 to be decreased.

If the devices 901 includes a hover gesture sensor, near air gestures can be used to define height of the virtual camera 150, and to identify the second and third components of the gesture. In FIG. 5B a hover detection zone 550 is present above a hover gesture enabled device 540b (the controller 180). As a user's finger 520 enters the hover detection zone 550, the presence of the hover gesture of the finger 520 is recognised in execution of step 230 as the initial touch input. The height of the virtual camera 150 is determined based on a height of the hover gesture. An initial touch input icon 560 is displayed, and a height indicator 510b is displayed on the display screen 914 with the virtual camera height set to the default value. The user can continue to move the finger 520 through a bottom threshold 530 to trigger the module 901 to set a new virtual camera height. The user's finger 520 can subsequently move back up through the threshold layers 530 and 550. To set the height of the virtual camera 150, the change in height is shown on the height indicator 510b. The interactions described in relation to FIG. 5B indicate how vertical hover gestures can be used to set camera height. Alternatively, the user could hold the finger 520 in the hover detection zone 550 for a duration longer than the 500 ms threshold, and the application 900 recognises and registers the finger position as a prolonged touch input. The prolonged touch input causes the height indicator 510b and the initial touch input icon 560 to be shown and the height of the virtual camera 150 to be set.

When the users finger 520 moves in a horizontal direction in a continuous motion away from the initial touch input location (e.g., 570) the application 933 recognises the finger motion as the second part of the touch gesture input, the first swipe input, for example an input 575. The first swipe 575 and a second swipe 580 inputs can occur as touch gestures or as hover gestures or dragging by a mouse. An extent of limits of the virtual camera 150 is determined in a similar manner to FIG. 3A. Accordingly, the second and third motions identified at steps 240 and 250 can relate to hover swipe gestures if the first, second and third gestures form a single continuous gesture.

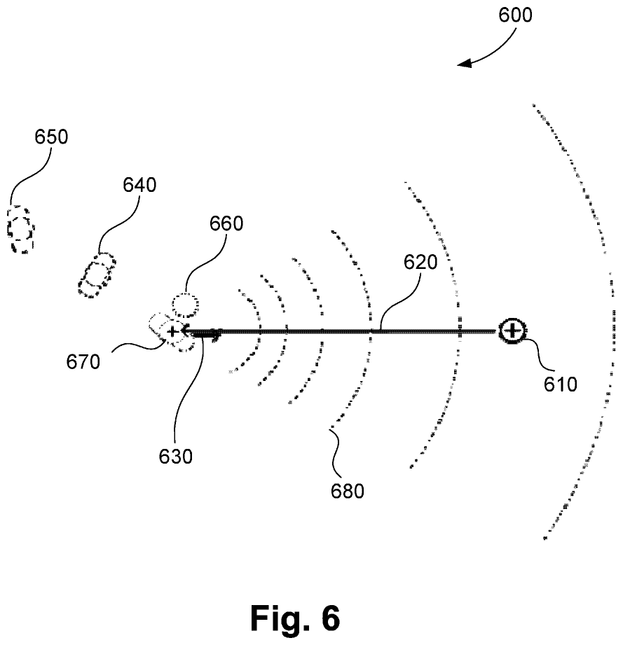

FIG. 6 shows an alternative arrangement 600 of configuring the virtual camera 150. The method used in the arrangement 600 sets a focal distance and depth of field of the virtual camera 150 using the three part gesture. The focal distance relates to a distance from the virtual camera 150 at which objects are in focus. The depth of field relates to extents either side of the focal distance in which objects are in focus. Outside of the depth of field objects are out of focus, and become increasingly out of focus the further the objects are from the focal distance.

At step 220 of the method 200, the controller 180 receives a touch gesture input on the synthesised interaction view 191. At step 230 a first part of the touch gesture is recognised by the video processing unit 905 as an initial touch input 610. The video processing unit 905 associates the initial touch input 610 with a location on the synthesised interaction view 191. The virtual camera 150 is positioned at the location of the initial touch input 610.

At step 230 of the method 200 the controller 180 receives a second part of the touch gesture input, being a continuous motion away from the location of the initial touch input 601. The video processing unit 905 recognises the second touch gesture as a swipe gesture, and records the gesture as first swipe input 620. The virtual camera 150 is created in step 260 using the position at 610 and oriented so that a line of sight of the virtual camera 150 follows the direction of the first swipe input 620. In the arrangement of FIG. 6, when the first swipe gesture 620 extends toward and ends on a second object 670, the application 933 sets the focal distance (focus) of the virtual camera 150 at the location of the second object 670. The focal distance in some arrangements is adjusted to track the second object 670 as the object 670 moves around the field 110. In other arrangements, the determined focal distance of the virtual camera 150 is a static focal distance, regardless of subsequent motion of the object 670.

In the arrangement relating to FIG. 6, at step 250 the controller 180 receives a third part of the touch gesture input with continuous motion away from the end of the first swipe input 620. The continuous touch input is recognised to be tracing back along the trajectory of the first swipe input 620, or at a threshold angle of less than 10 degrees for example. The video processing unit 905 recognises the continuous touch input as a second swipe input 630 for setting depth of field and displays depth of field guides 680. The depth of field guides 680 extend past the initial touch input 630's location. The second swipe input 630 can also extend past the initial touch input 610's location. The second swipe input 630 can be made to snap to individual ones of the guides 680 that are closest. In step 250 the video processing unit 905 determines the length of the second swipe input 630. The determined length is used to determine the depth of field of the virtual camera 150. Effectively, if the second swipe gesture traces back along a trajectory of the first swipe gesture, the virtual camera 150 is configured to have a depth of field based on the length of the second swipe input.

Objects 660, 640 and 650 are at various distances from the focal distance located at the second object 670. Accordingly, the objects 660, 640 and 650 are all slightly out of focus in the view generated for the virtual camera 150. The further the objects 660, 640 and 650 are from the second object 670 and focal distance, the more out of focus (blurred) the objects 660, 640 and 650 are in the view generated for the virtual camera 150.

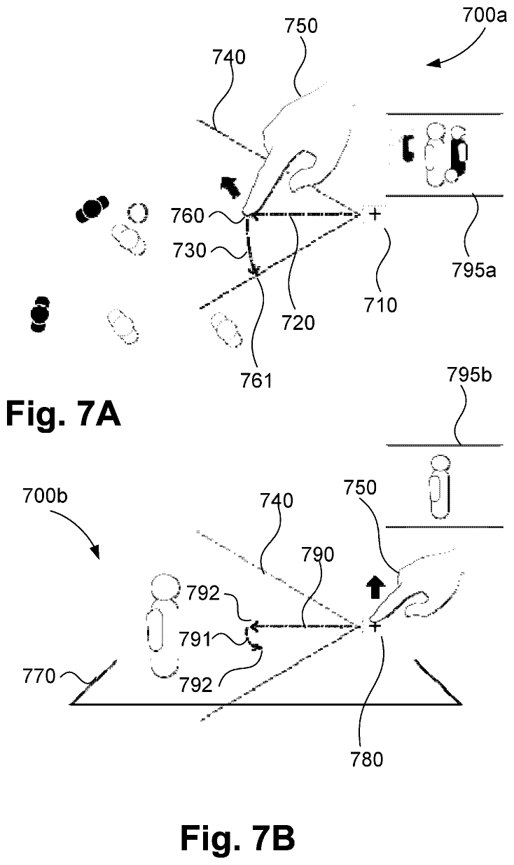

FIGS. 7A and 7B show arrangements for re-configuring or editing the existing virtual camera 150. An arrangement 700a in FIG. 7A shows the interactions required to re-configure the virtual camera position, line of sight, or field of view where the user interacts with a touch screen of the controller 180. An arrangement 700b in FIG. 7B shows the interactions required to re-configure the virtual camera height using the touch screen.

As shown in FIG. 7A, at step 220 of the method 200 the controller 180 receives a touch gesture input on the synthesised interaction view 191 in the same location as the existing virtual camera 150. The method 220 executes to display guides 710, 720 and 730 representing the original gesture inputs used to configure the virtual camera 150. The user can re-trace the three part gesture modifying any of the gesture parts to re-configure the virtual camera 150. Alternatively the user can touch on end points 760 or 761 of either the first swipe guide or first motion 720 or second swipe guide or second motion 730 respectively to change characteristics of the virtual camera 150. In some arrangements, the endpoints 760 and 761 are highlighted in the synthesised interaction view 131 so that the user can recognise, choose and modify an endpoint with ease. For example the user can touch on the end point 760 at the end of the first swipe guide 720 and implement a drag or swipe gesture to change the angle of the first swipe input. The drag or swipe gesture changes the line of sight of the virtual camera 150. Moving the endpoint 760 of the second swipe guide 730 changes the original field of view 740 of the virtual camera 150. Moving the initial touch guide 710 moves the position of the virtual camera 150. Any variations are represented in the virtual camera preview 795a.

As shown in FIG. 7B, the synthesised interaction view 191 represents a side view of the field 110. When the controller 180 receives a touch gesture input on the synthesised interaction view 191 in the same location as the existing virtual camera 150, guides 780, 790 and 791, also referred to as interaction planes, representing the original gesture inputs are displayed by execution of the application 933. When the synthesised interaction view 191 is a horizontal or perspective view across the field 110, as shown in FIG. 7B, display of the guides 780, 790 and 791 changes. When the user moves the initial touch guide 780 up or down, the height of the virtual camera 150 is changed as the application 933 interprets an interaction plane perpendicular to the current synthesised interaction view 191. The interaction planes for the other guides 790, 791 and endpoints 792 have not changed. The interaction planes for the other guides 790, 791 and endpoints 792 move parallel to the ground plane 770 as in FIG. 7A. An updated virtual camera view 795b is shown. Effectively, the controller 180 receives a gesture updating one of the first swipe and the second swipe gestures and the application 933 operates to re-configure the virtual camera 150 accordingly.

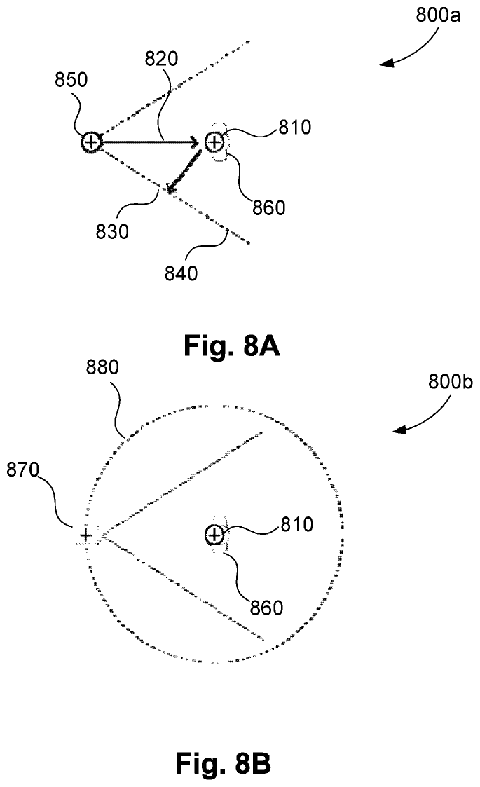

FIGS. 8A and 8B show a set of views 800a and 800b showing operation a method of configuring the virtual camera 150 so that the virtual camera 150 is tethered to an object, such as a player on the field 110, with an orbiting or otherwise constrained motion path. In the example of FIG. 8, the virtual camera 150 will move with an object as the object changes location, but the distance of the virtual camera 150 from the object is constrained.

In FIG. 8A, the first part of the touch gesture is recognised by the video processing unit 905 as an initial touch input (initial or pointing operation) 810 on the synthesised interaction view 191. The initial touch input 810 is in the same location as an object 860, in this case a player.

At step 240 the controller 180 receives a second part of the touch gesture input having a continuous motion away from the location of the initial touch input 810. The video processing unit 905 recognises the second part of the touch gesture as a swipe gesture, and records the second part of the touch gesture as a first swipe input (first motion of the further operation) 820.

At step 250 the controller 180 receives a third part of the touch gesture (second motion of the further operation) with continuous motion away from the end of the first swipe input 820 at an angle which is between two thresholds. For example, the threshold may relate to an angle between ten and forty five degrees from the first swipe input 820. A maximum threshold of forty five degrees approximates an extreme wide angle lens. The minimum threshold of ten degrees approximates an extreme telephoto lens.

As the initial touch input 810 is at a location of an object, and the second swipe motion is at an angle relative to the first swipe between two predetermined thresholds, the virtual camera is generated to orbit the object. The application 933 recognises that the three part gesture defines a tethered virtual camera and configures a tethered virtual camera 870 to be placed at the end of the first swipe input 820 with a line of sight centred on the object 860 selected with the initial touch input 810. The length of the first swipe gesture or the first motion 820 is used to determine a radius of an orbital path 880, as shown in FIG. 8B. The orbital path 880 constrains movement of the tethered virtual camera 870 around the object 860. The tethered virtual camera 870 can move automatically or by manual navigation, around the object 860. The tethered virtual camera can be moved toward and away from the object 860 but has a normal position on the orbital path 880. When the object 880 moves around the field 110 the tethered virtual camera 870 moves in the same direction and by the same amount.

The arrangements described are applicable to the computer and data processing industries and particularly for the video broadcast industries. The arrangements described are particularly suited to live broadcast applications such as sports or security.

In using the three-component continuous gesture, the arrangements described provide an advantage of allowing a user to generate a virtual camera in near real-time as action progresses. The user can configure the virtual camera with ease using a single hand only, and control at least 3 parameters of the virtual camera—location, direction and field of view. Further, the arrangements described can be implemented without comprising a specialty controller. In contrast, a device such as a tablet can be used to configure the virtual camera on the fly.

In one example application, a producer is watching live footage of a soccer game and predicts the ball will be passed to a particular player. The producer can configure a virtual camera having a field of view including the player using the three-component gesture.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A computer-implemented method of configuring a virtual camera, the method comprising:
receiving, at an interface of an electronic device, a pointing operation identifying a location in a representation of a scene displayed in a first display region;
receiving, at the interface, a further operation in the first display region, the further operation comprising a continuous motion away from the location of the pointing operation; and
configuring the virtual camera based on the location of the pointing operation and at least a direction of the further operation, wherein an image corresponding to the configured virtual camera is displayed in a second display region, the second display region being different from the first display region.

2. The method according to claim 1, wherein the location identifying operation comprises selecting, in the first display region, a location where the virtual camera is to be positioned.

3. The method according to claim 1, wherein the interface is a touchscreen, the pointing operation is a touch gesture and the further operation is a swipe operation.

4. The method according to claim 1, wherein the interface is a mouse, the pointing operation is a click and the further operation is a drag operation.

5. The method according to claim 1, wherein an orientation of the virtual camera is configured based on the direction of the continuous motion.

6. The method according to claim 5, wherein:
the continuous motion away from the location of the pointing operation is a first motion,
the further operation additionally comprises a second motion being a continuous motion from the first motion; and
a field of view of the virtual camera is configured based on a length of the second motion.

7. The method according to claim 1, wherein the scene is associated with a plurality of predefined virtual cameras and configuring the virtual camera comprises selecting one of the plurality of predefined virtual cameras.

8. The method according to claim 1, wherein the virtual camera configuration determines an initial location, an initial orientation and an initial field of view of the virtual camera.

9. The method according to claim 1, wherein the virtual camera is configured and the image is displayed in the second display region in real time as the further operation is received.

10. The method according to claim 6, wherein the field of view of the virtual camera is determined based on an angle of the second motion relative to the first motion, the angle being within a predetermined threshold.

11. The method according to claim 3, further comprising determining a height of the virtual camera based on at least one of a duration of the touch gesture or a pressure applied to the touchscreen during the touch gesture.

12. The method according to claim 1, wherein the pointing operation comprises selecting a location of an object in the scene and the virtual camera is configured to display a viewpoint of the object.

13. The method according to claim 6, wherein the virtual camera is configured to track an object when the first motion ends on the object.

14. The method according to claim 1, wherein the representation of the scene displayed in the first display region represents a map of a playing field where the virtual camera is configured.

15. The method according to claim 6, wherein, if the second motion traces back along a trajectory of the first motion, the virtual camera is configured to have a depth of field based on a determined length of the second motion.

16. The method according to claim 6, further comprising detecting, at the interface, a further selection at the location in the scene, displaying an indication of the selection, the first motion and the second motion; and receiving a selection updating one of the first motion and the second motion to re-configure the virtual camera.

17. The method according to claim 6, wherein if the pointing operation is at a location of an object in the scene, and the second motion is at an angle relative to the first motion between two predetermined thresholds, the virtual camera is configured to orbit the object.

18. The method according to claim 17, wherein a length of the first motion is used to determine a radius of an orbital path of the virtual camera relative to the object.

19. The method according to claim 1, wherein the first display region and the second display region are different parts of the electronic device.

20. The method according to claim 1, wherein the first display region and the second display region are in different display devices respectively, the different display devices being connected with the electronic device.

21. A non-transitory computer-readable medium having a computer program stored thereon for configuring a virtual camera, the program comprising:
code for receiving, at an interface of an electronic device, a pointing operation identifying a location in a representation of a scene displayed in a first display region;
code for receiving, at the interface, a further operation in the first display region, the further operation comprising a continuous motion away from the location of the pointing operation; and
code for configuring a virtual camera based on the location of the pointing operation and at least a direction of the further operation, and displaying an image corresponding to the configured virtual camera in a second display region, the second display region being different from the first display region.

22. A system, comprising:
an interface;
a display;
a memory; and
a processor, wherein the processor is configured to execute code stored on the memory for implementing a method of configuring a virtual camera, the method comprising:
receiving, at the interface, a pointing operation identifying a location in a representation of a scene displayed in a first display region;
receiving, at the interface, a further operation in the first display region, the further operation comprising a continuous motion away from the location of the pointing operation; and
configuring the virtual camera based on the location of the pointing operation and at least a direction of the further operation; wherein an image corresponding to the configured virtual camera is displayed in a second display region, the second display region being different from the first display region.

23. A tablet device adapted to configure a virtual camera, comprising:
a touchscreen;
a memory;
a processor configured to execute code stored on the memory to:
display a video representation of a scene in a first region of the touchscreen;
receive, at the touchscreen, a pointing operation identifying a location in the scene in the first region;
receive, at the touchscreen, a further operation in the first region, the further operation comprising a continuous motion away from the location;
configure the virtual camera based on the location of the pointing operation and at least a direction of the further operation; and
display an image corresponding to the configured virtual camera in a second region of the touchscreen, the second region being different from the first region.
